(19) United States
(12) Patent Application Publication
(10) Pub. No.: US 2013/0086915 A1
(43) Pub. Date: Apr. 11, 2013

(54) FILM COOLED COMBUSTION LINER ASSEMBLY

(71) Applicants: David William Cihlar, Greenville, SC (US); Ronald James Chila, Greer, SC (US); Patrick Benedict Melton, Horse Shoe, NC (US); William David York, Greer, SC (US)

(72) Inventors: David William Cihlar, Greenville, SC (US); Ronald James Chila, Greer, SC (US); Patrick Benedict Melton, Horse Shoe, NC (US); William David York, Greer, SC (US)

(73) Assignee: General Electric Company

(21) Appl. No.: 13/267,994

(22) Filed: Oct. 7, 2011

(51) Int. Cl. F02C 7/18

(52) U.S. Cl. 60/755; 60/806

(57) ABSTRACT

A combustion liner assembly is provided and includes a combustion liner and a transition piece. A portion of the transition piece is circumferentially disposed around a portion of the combustion liner. A seal is attached to the transition piece, and the seal is configured to apply a compressive force to an aft end of the combustion liner.

### BACKGROUND OF THE INVENTION

The subject matter disclosed herein relates to gas turbine engines and, more specifically, to a system for cooling a combustion liner used in a combustor of a gas turbine engine.

Gas turbine engines typically include a combustor having a combustion liner defining a combustion chamber. Within the combustion chamber, a mixture of compressed air and fuel is combusted to produce hot combustion gases. The combustion gases may flow through the combustion chamber to one or more turbine stages to generate power for driving a load and/or a compressor. Typically, the combustion process heats the combustion liner due to the hot combustion gases. Unfortunately, as firing temperatures have increased existing cooling systems may not adequately cool the combustion liner in all conditions.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

According to one aspect of the present invention, a combustion liner assembly is provided and includes a combustion liner and a transition piece. A portion of the transition piece is circumferentially disposed around a portion of the combustion liner. A seal is attached to the transition piece, and the seal is configured to apply a compressive force to an aft end of the combustion liner.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of a turbine system having a combustor liner with a patterned surface for enhanced cooling, in accordance with an embodiment of the present technique;

FIG. 2 is a cutaway side view of the turbine system, as shown in FIG. 1, in accordance with an embodiment of the present technique; and

FIG. 3 illustrates a partial cross-sectional view of the combustion liner assembly, according to an aspect of the present invention.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments. Additionally, it should be understood that references to “one embodiment” or “an embodiment” of the present invention are not intended to be interpreted as excluding the existence of additional embodiments that also incorporate the recited features.

Before continuing, several terms used extensively throughout the present disclosure will be first defined in order to provide a better understanding of the claimed subject matter. As used herein, the terms “upstream” and “downstream,” when discussed in conjunction with a combustion liner, shall be understood to mean the proximal end of the combustion liner and the distal end of the combustion liner, respectively, with respect to the fuel nozzles. That is, unless otherwise indicated, the terms “upstream” and “downstream” are generally used with respect to the flow of combustion gases inside the combustion liner. For example, a “downstream” direction refers to the general direction in which a fuel-air mixture combusts and flows from the fuel nozzles towards a turbine, and an “upstream” direction refers to the general direction opposite the downstream direction, as defined above. Additionally, the term “downstream end portion,” “coupling portion,” or the like, shall be understood to refer to an aft-most (downstream most) portion of the combustion liner. As will be discussed further below, the axial length of the downstream end portion of the combustion liner, in certain embodiments, may be the as much as 20 percent the total axial length of the combustion liner. The downstream end portion (or coupling portion), in some embodiments, may also be understood to be the portion of the liner that is configured to couple to a downstream transition piece of the combustor, generally in a telescoping, concentric, or coaxial overlapping annular relationship. Further, where the term “liner” appears alone, it should be understood that this term is generally synonymous with “combustion liner.”

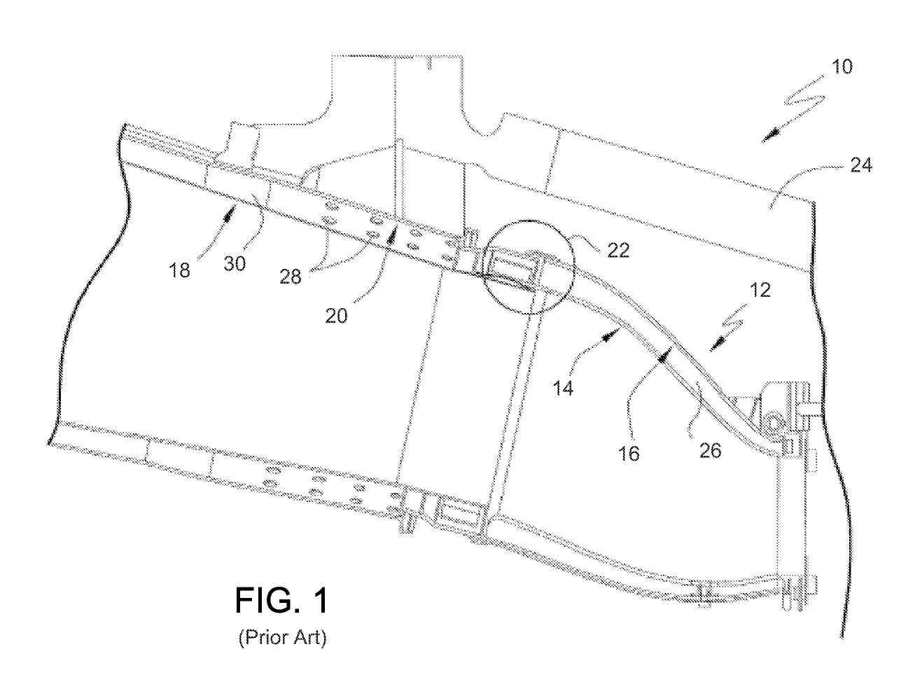

FIG. 1 schematically depicts an interface region between the aft end of one known combustion liner and the forward end of a transition piece in can-annular type gas turbine combustor 10. As can be seen in this example, the transition piece 12 includes a radially inner transition piece body 14 and a radially outer transition piece impingement sleeve 16 spaced from the transition piece body 14. Upstream thereof is the combustion liner 18 and the combustor flow sleeve 20 defined in surrounding relation to the liner.

Flow from the gas turbine compressor (not shown) enters into a case 24. About 50% of the compressor discharge air passes through apertures (not shown in detail) formed along and about the transition piece impingement sleeve 16 for flow in an annular region or annulus 26 between the transition piece body 14 and the radially outer transition piece impingement sleeve 16. The remaining approximately 50% of the compressor discharge flow passes into flow sleeve holes 28 of the upstream combustion liner flow sleeve 20 and into an annulus 30 between the flow sleeve 20 and the liner 18 and eventually mixes with the air from the downstream annulus 26. The combined air eventually mixes with the gas turbine fuel in the combustion chamber.

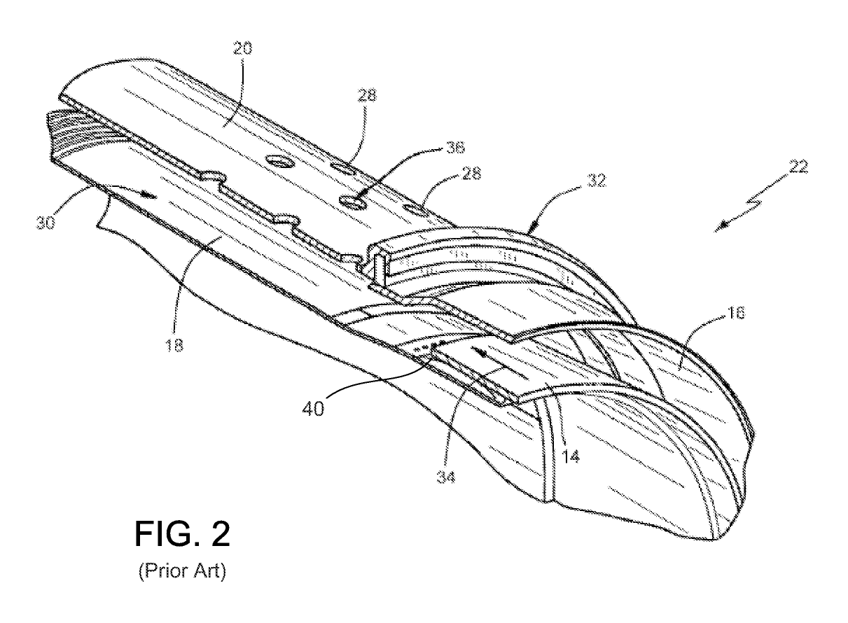

FIG. 2 illustrates in greater detail the transition region (or the connection) 22, as shown in FIG. 1, between the transition piece/impingement sleeve 14, 16 and the combustion liner/flow sleeve 18, 20. Specifically, the impingement sleeve 16 (or second flow sleeve) of the transition piece 14 is received in telescoping relationship in a mounting flange 32 or the aft end of the combustor flow sleeve 20 (or first flow sleeve). The transition piece 14 also receives the combustion liner 18 in a telescoping relationship. The combustor flow sleeve 20 surrounds the combustion liner 18 creating flow annulus 30 (or first flow annulus) therebetween. It can be seen from the flow arrow 34 in FIG. 2, that crossflow cooling air traveling in annulus 26 continues to flow into annulus 30 in a direction perpendicular to impingement cooling air flowing through the cooling holes 28 (see flow arrow 36) formed about the circumference of the flow sleeve 20 (while three rows are shown in FIG. 2, the flow sleeve may have any number of rows of such holes).

As previously noted, the hot gas temperature at the aft end of the liner 18, and the connection or interface region 22, is approximately 2800° F. However, the liner metal temperature at the downstream, outlet portion of interface region 22 is preferably less than 1500° F. As described in greater detail below, to help cool the liner 18 to this lower metal temperature range during passage of heated gases through the interface region 22, the aft end of the liner 18 has been formed with axial passages through which cooling air is flowed. This cooling air serves to draw off heat from the liner and thereby significantly lower the liner metal temperature relative to that of the hot gases.

A hula seal 40 is typically attached to the aft end of the liner 18. Unfortunately, a substantial portion of the liner is required for the attachment of the hula seal 40. This extra liner material or section increases the thermal mass of the liner and increases the amount of the liner to be cooled by the impingement cooling air. As firing temperatures increase, the aft end of the liner (e.g., the region where the transition piece overlaps the combustion liner) becomes more difficult to cool effectively with a limited amount of cooling air.

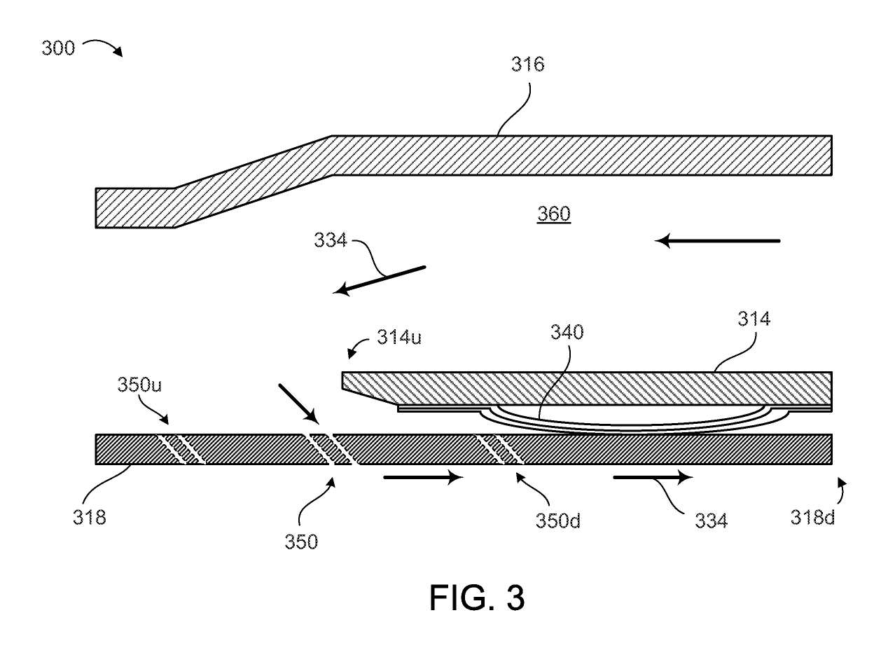

FIG. 3 illustrates a partial cross-sectional view of the combustion liner assembly 300, according to an aspect of the present invention. The combustion liner 318 has an aft end (or downstream end) 318d located within an upstream portion 314u of transition piece 314. In other words, the upstream portion of the transition piece 314 is circumferentially disposed around an aft (or downstream) portion of the combustion liner 318. A compression type seal 340, such as a hula seal, is attached to the transition piece 314 and is configured to apply a compressive force to the aft end or aft portion of the combustion liner 318.

According to one aspect of the present invention, the aft end 318d of combustion liner 318 is configured to terminate near a downstream end of seal 340. This configuration allows the use of a shorter combustion liner, which in turn reduces the thermal mass in the aft end portion of the combustion liner. The axial length of the aft end portion of the combustion liner is also reduced, and these features combined improve the cooling effectiveness of the cooling air passing through cooling holes 350. The cooling air (indicated by flow arrows 334) cool the combustion liner by film cooling. Film cooling works by injecting cooler air from outside the liner to just inside the liner. This creates a thin film of cool air that protects the liner and reduces the temperature of the liner in the region of the film cooling. A shorter aft end portion of the liner enables the cooling air to maintain a higher temperature differential with respect to the inner combustion liner temperatures (i.e., the difference between the temperature of the cooling air and the combustion temperatures within liner 318 is greater compared to previous known liner configurations). In addition, a shorter liner reduces the thermal mass, which also leads to improved cooling effectiveness by the cooling air flow 334.

Locating the hula seal 340 on the transition piece 314 allows for the aft end 318d of the liner 318 to be shorter, which allows for more effective cooling of the aft end for higher firing temperature units. The improved location of the hula seal 340 in conjunction with film cooling allows for improved cooling with a limited amount of cooling air. Another benefit of these two items is that it allows for the film or cooling holes 350 to be located further downstream than previously allowable, allowing for further improvement in cooling effectiveness.

The plurality of cooling holes 350 may be located near an upstream end 314u of transition piece 314. Alternatively, or additionally, cooling holes may also be provided upstream of the transition piece (as indicated by cooling holes 350u) or downstream of the transition piece 314 (as indicated by cooling holes 350d).

Compressed air discharged by the compressor (not shown) may be received in the annular passage 360 (defined by the impingement sleeve 316 and the transition piece 314) through inlets (not shown). This cooling air flow may then be directed through cooling holes 350. In the present embodiment, the cooling holes 350 are circular-shaped holes, although in other implementations, the cooling holes 350 may be slots, or a combination of holes and/or slots of other geometries.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A combustion liner assembly, comprising:
a combustion liner;
a transition piece, wherein a portion of the transition piece is circumferentially disposed around a portion of the combustion liner;
a seal attached to the transition piece, wherein the seal is configured to apply a compressive force to an aft end of the combustion liner.

2. The combustion liner assembly of claim 1, wherein the aft end of the combustion liner is configured to terminate near a downstream end of the seal.

3. The combustion liner assembly of claim 1, wherein the seal is a compression type seal.

4. The combustion liner assembly of claim 3, wherein the seal is a hula seal.

5. The combustion liner assembly of claim 1, the combustion liner further comprising:
a plurality of cooling holes located near an upstream end of the transition piece;
wherein the plurality of cooling holes are configured to provide film cooling to at least a portion of the combustion liner.

6. The combustion liner assembly of claim 5, wherein the plurality of cooling holes are located upstream of the transition piece.

7. The combustion liner assembly of claim 5, wherein the plurality of cooling holes are located downstream from an upstream portion of the transition piece.
